(19) United States
(12) Patent Application Publication
(10) Pub. No.: US 2005/0074665 A1
(43) Pub. Date: Apr. 7, 2005

(54) System for storing and/or transforming energy from sources at variable voltage and frequency

(75) Inventors: Placido M Spaziante, Bangkok (TH); Krisada Kampanatsanyakorn, Bangkok (TH); Andrea Zocchi, Firenze (IT)

Correspondence Address: CONNOLLY BOVE LODGE & HUTZ LLP, SUITE 800, 1990 M STREET NW, WASHINGTON, DC, 20036-3425, US

(73) Assignee: SQUIRREL HOLDINGS LTD, George Town (KY)

(21) Appl. No.: 10/495,139

(22) PCT Filed: Oct. 14, 2002
(86) PCT No.: PCT/IT02/00653

(30) Foreign Application Priority Data
Nov. 16, 2001 (IT) VA2001A000041

(51) Int. Cl. H01M 8/20

(52) U.S. Cl. 429/50

(57) ABSTRACT

A method of storing electric energy from an AC source of a certain frequency, whose value is not pre-established and is even variable, in one or more redox batteries composed of a plurality of elementary cells electrically in series and having a certain cell voltage, is disclosed. The method is implemented in an outstandingly versatile system for storing energy in one or more redox batteries easy to realize and capable of storing energy in a redox battery in highly efficient manner independently of the electric characteristics with which it is generated, and capable of exploiting the redox battery even as a “buffer” for transforming energy from an electrical source of certain voltage and frequency characteristics for supplying it to a load or outputting it on the electricity distribution network at different electric characteristics.

The present invention relates to systems for storing and/or transforming energy based on redox batteries.

Exploitation of renewable energy sources, “load-leveling” in generation and distribution networks of electric energy, often employ batteries and in particular redox batteries.

The use of storage batteries is necessary in “stand-alone” photovoltaic (solar) panels systems not connected to any power distribution grid. Redox flow batteries offer many advantages for these types of application compared to other types of storage batteries.

Among redox flow batteries, all vanadium batteries, i.e. batteries that employ a vanadium-vanadium redox couple in the negative electrolyte as well as in the positive electrolyte, are particularly advantageous.

Performances of a storage plant employing vanadium redox flow batteries are reported and analyzed in the article: “Evaluation of control maintaining electric power quality by use of rechargeable battery system”, by Daiichi Kaisuda and Tetsuo Sasaki IEEE 2000.

There is a wealth of literature on redox flow batteries and in particular about vanadium redox flow batteries. Therefore, a detailed description of the peculiarities and advantages of such batteries in respect to other types of batteries does not seem necessary in order to fully describe the present invention.

Among the many advantages of redox flow batteries, it is worth remarking though their suitability to being charged even at different charging voltages. To accomplish this, intermediate taps of the electrical chain, constituted by the elementary cells in electrical series that constitute the battery, may be used.

Depending on the voltage of the available source, most appropriate taps are selected for coupling to the recharging voltage an appropriate number of cells.

This is possible because, differently from other types of storage batteries, in redox flow battery systems energy is stored in the electrolytes that circulate through the cells and that are stored in separated tanks. The battery represents exclusively the electrochemical device where electric energy transforms in chemical energy and viceversa, and the electrodes of the cells do not undergo any chemical transformation during charge and discharge processes.

In renewable energy sources plants, there are conditions, generally of a variable nature, that may affect the transformation process and the eventual energy storage.

In case of aeolian generators there is the problem of providing for constant characteristics of the electrical energy that is supplied to electric loads. In case a DC generator (dynamo) is used, the generated voltage varies with the rotation speed and each aeolian generator is often provided with mechanical devices to increase the useful range of wind conditions. In case an alternator is used to generate an AC voltage, speed variations cause frequency variations of the generated AC voltage and rectifiers DC-DC converters and inverters may be necessary. In case it is necessary to store electrical energy in batteries, a battery charger must be coupled to the alternator.

Similar problems are present also in hydroelectric power plants.

When interconnection to the local mains is contemplated, for example in all those applications in which electric power eventually produced on site from renewable energy sources is destined to satisfy partially or during periods of favorable water or climatic conditions the local energy demand, outputting any eventual excess of power on the distribution networks, the electric power produced on site must have the same voltage and frequency characteristics of that of distribution network.

The use of redox batteries for energy storage even in these plants, interconnected to the local mains, may increase considerably the exploitation of natural renewable energy sources, allowing the generation of electric power even in sub-optimal conditions that would not allow to meet the standard electrical voltage and frequency characteristics required by local electric loads as well as for an eventual output of excess power on the distribution mains (in order to gain energy credits).

It is clear that the design of these power plants exploiting renewable energy sources of unpredictable characteristics implies the identification of ranges of useful conditions. On that basis, rectifiers, DC-DC converters, transformers, inverters, mechanical transmission ratio converters, and the like are required for allowing exploitation of renewable energy sources for periods and at levels economically convenient in respect to the investment. As already said, the use of storage batteries is a necessary condition to enhance exploitation.

In many cases the cost of these ancillary devices and accessories may surpass the cost of the generator and/or of the eventual storage batteries. Moreover, a low efficiency figure of these devices may severely lower the overall efficiency figure of the whole renewable energy source plant.

Generally, electricity distribution networks and as a consequence the majority of electrical devices operate with an AC voltage because it is relatively easy to modify using simple static machines such as electric transformers.

This has also imposed the establishment of a standard (50 or 60 Hz) mains frequency (AC) and all electrical machines, even devices of common household use, are designed, and/or operated (for example alternators) at this fixed mains frequency.

On the other side, batteries are typically capable of storing and supplying electric energy in a DC mode.

Interfacing problems between these two systems are evident and are commonly overcome by employing battery chargers on one side and inverters on the other side. These ancillary devices significantly lower the overall efficiency of the energy transformation processes (charge and discharge processes).

It is evident the need and/or the utility to interface two distinct electrical systems of generation and/or distribution of AC power and/or of storage and successive release of electric power using a redox battery such to allow to efficiently store energy in the battery independently of the electric characteristics of the electrical source in terms of voltage and/or of frequency.

This important objective is reached by the present invention relating to an outstandingly versatile system for storing energy in one or more redox batteries, easy to realize and capable of storing energy in a redox battery in highly efficient manner independently of the electric characteristics with which it is generated, and capable of exploiting the redox battery even as a “buffer” for transforming energy from an electrical source of certain voltage and frequency characteristics, for supplying it to a load or outputting it on the electricity distribution network at different electric characteristics.

A inverter system according to the present invention is capable of exploiting any DC and AC source with voltage lower than or equal to a certain pre-established maximum limit value, independently of variations of the source voltage and/or of frequency.

Differently from traditional battery charger systems based on the use of functional circuits such as DC-DC converters, rectifiers, voltage stabilizers, current regulators and the like, the energetic efficiency of the charge process of the battery in the system of this invention is substantially independent from the electric characteristics of the electrical source.

The system of the invention, in its most basic form, can be compared to a universal battery charger capable of handling AC power sources of any voltage and of any frequency, as well as DC power sources (within upper limit values). This extraordinary flexibility offers many possibilities to optimize power generation systems. For example it allows the use of alternators instead of more expensive and less reliable dynamos in power plants exploiting renewable energy sources such as aeolian, hydraulic power plants or in any case employing rotating organs.

It is evident the exceptional versatility of the battery charger system of this invention, that can be used in practice with any source of electrical power.

The ability of the redox battery charger system of this invention of operating even with an AC input without requiring electric transformers, rectifiers, voltage regulators, etc., eventually even with the standard AC mains voltage, makes it ideal for realizing efficient control systems of electric motors, as will be described in detail later on.

The inductorless or transformerless inverter system described in the PCT patent application No. PCT/IT02/00448 in the name of the same Applicant is able to provide DC or AC power at a programmable voltage and/or frequency from energy stored in a redox battery. When the inverter system described in said prior application is associated to the battery charger system of the present invention, the whole constitutes an extraordinarily efficient and versatile system that can be used in many applications. For instance, it can be used as a “frequency transformer” capable of absorbing energy from an electrical source at DC or AC voltage of any fixed or variable frequency and to output an AC voltage at a pre-established fixed frequency and voltage, for example at the voltage and frequency of electrical mains, or at any frequency, even variable to control a synchronous electric motor, as it will be described more in detail later on.

These abilities of the system of the present invention makes it suitable to be used as a (voltage) transformer even at very low frequencies (few Hz), a frequency at which a common transformer would be inefficient and encumbering.

The ability of implementing a “transformer” of electrical characteristics in a variety of applications, is independent from an intrinsic capacity of storing energy, which is always a resource (UPS function) both whether this ability is exploited or not in the considered application.

The method of storing electric energy from an AC source of a certain frequency, whose value is not pre-established and is even variable, in one or more redox batteries composed of a plurality of elementary cells electrically in series and having a certain cell voltage, is characterized in that it comprises the operations of:
rectifying the AC voltage by means of a full wave rectifier;
providing for a number N of voltage taps along said series of elementary cells of redox battery;
providing for a number N of power switches each connecting an intermediate tap or the positive terminal of the electrical series of elementary cells to the output node of the rectifier;
connecting the negative terminal of the electrical series of elementary cells to a common potential node of the circuit;
detecting the null voltage of the rectified voltage producing a first conditioning and reset signal of a second conditioning signal;
detecting the peak of the rectified voltage producing said second conditioning and reset signal of said first conditioning signal;
switching sequentially and cyclically in a continuous mode and without overlappings said N switches one at the time from the instant of detection of the null voltage of the rectified wave acknowledged by the activation of said first conditioning signal, each for a certain time interval, up to the switch connecting the positive terminal of said series, inverting the scan direction upon detecting a voltage peak acknowledged by the activation of said second conditioning signal.

The method of this invention is self-adapting to variations of the frequency of the AC source that is exploited to charge the redox battery. In fact the algorithm is such to synchronize itself with the salient instants of the AC wave-form at every cycle.

According to an alternative and preferred embodiment, the method may further comprise monitoring the charge current flowing through the elementary cells of the battery comprised between the negative terminal thereof and the intermediate tap connected to the output node of the rectifier and comparing the charge current with a pre-established maximum threshold and with a pre-established minimum threshold, using a double threshold or window comparator, generating a third conditioning signal when one of said thresholds is exceeded. When said third conditioning signal is activated, the switch currently on is turned off and when the turn off has taken place (confirmed), the switch of the adjacent intermediate tap, at a higher or lower voltage than the previously connected intermediate tap, is turned on, depending on whether the maximum or the minimum current threshold has been exceeded.

According to such a preferred embodiment, adaptability and optimization of the charge process are enhanced should the instantaneous amplitude of the AC voltage vary even in an odd fashion as, in presence of irregular or strongly distorted waveforms in respect to the ideal sinusoid.

Under these conditions, in each quadrant the sequentially and cyclically driven switchings of the array of switches no longer take place at regular intervals, that is for phase intervals of the same duration of discretization of the voltage waveform in the quadrant, but they are slaved to the actual detection of a charge current greater or smaller than a maximum and a minimum threshold that may be predefined in function of the characteristics of the cells of the battery.

Moreover, while according to the basic method that contemplates only the self-synchronization of the succession of switching sequences of equal duration, at each detection of the zero and of the peak of the rectified waveform, the locations of the intermediate taps, in terms of number of intercepted cells, may reflect the relative sinusoidal function, in the case of implementation of the monitoring and comparing of the current, as in the above described alternative embodiment, the distribution of the intermediate taps may be uniform, that is for a substantially constant number of cells between a tap and the successive one. This is possible because the system is able of self-regulating the optimal duration of each switching phase in function of the objective datum of the charge current which is really forced through the cells currently included in the charge circuit during the succession of switching phases, both in a rising voltage quadrant as well as in a falling voltage quadrant of the rectified waveform.

In any case, the controlling and driving system of the power switches is such to prevent that more than one switch at the time be in conduction (turned on state of the relative power transistor). Techniques for ensuring that the turn on phases do not overlap are commonly used in many applications of integrated power devices (transistors), generally for safeguarding their integrity. In the context of the present invention, such a control of the turning on of the power switches is a functional requisite that is fundamental to prevent short-circuiting cells of the battery.

This condition of not overlapping of turning on phases can be commonly established by logic circuits that enable the turning on of the relative power transistor or even establish a guard interval between the turning off of a power transistor and the turning on of another power transistor.

The different aspects and advantages of this invention will be better illustrated through the following description of several embodiments and by referring to the attached drawings, wherein:

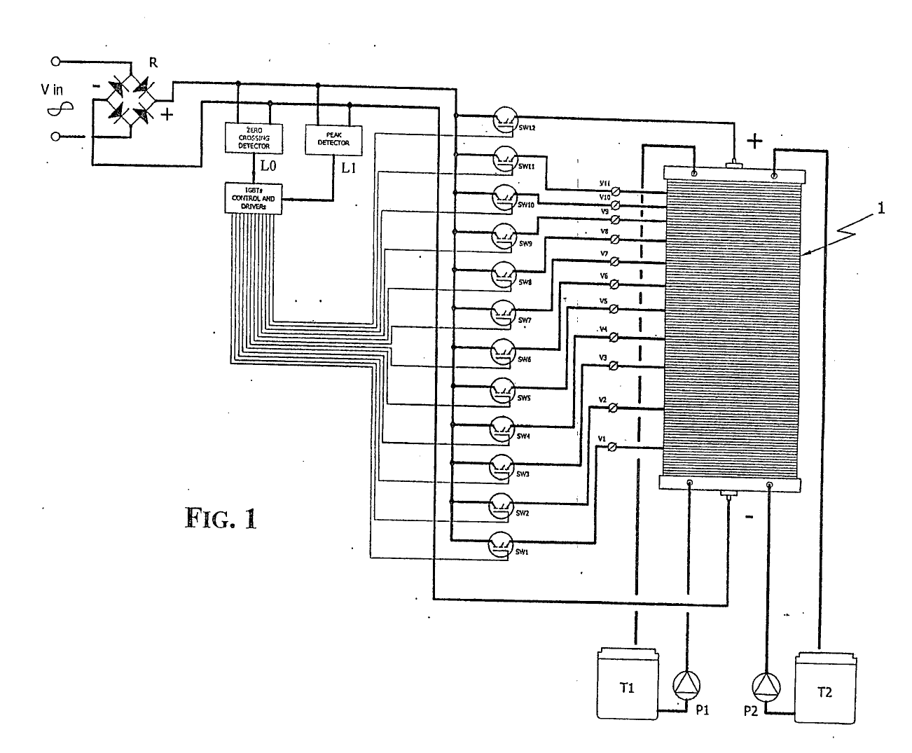

FIG. 1 is a functional block diagram of a battery charger system for a redox battery of the invention;

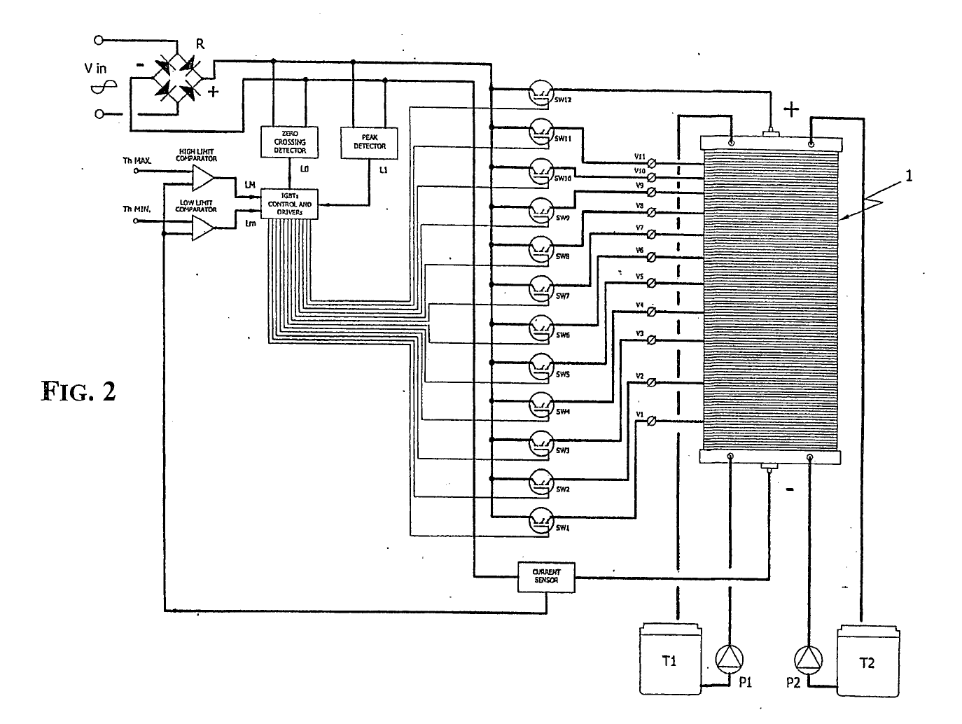

FIG. 2 is a functional block diagram of the battery charger system for a redox battery of the invention, according to an alternative embodiment;

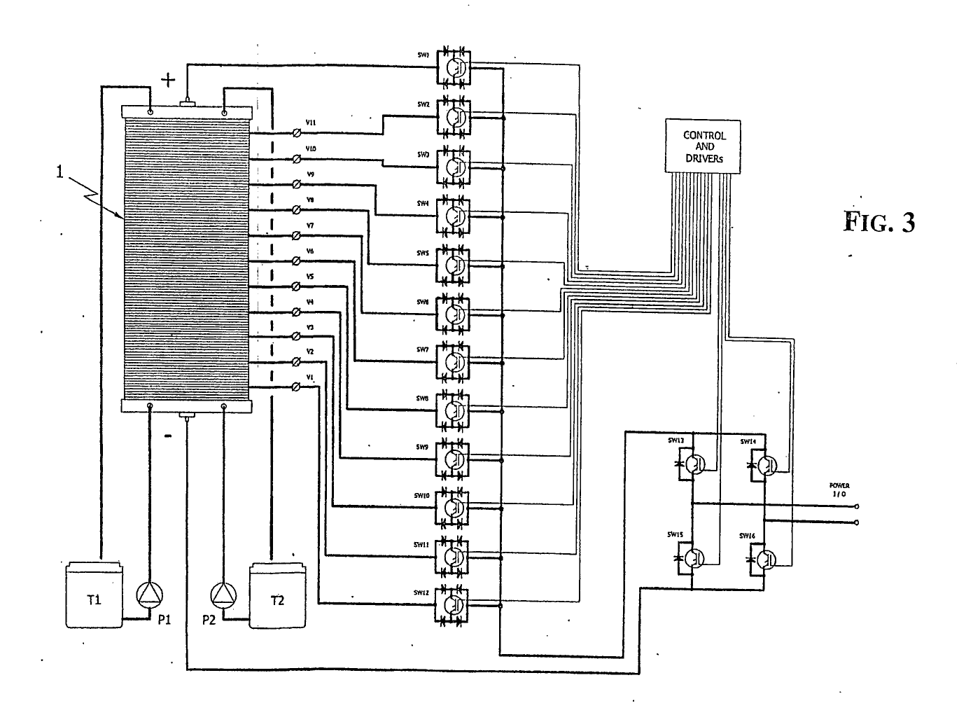

FIG. 3 is a functional block diagram of a battery charger system of the invention functionally similar to that of FIG. 1, further comprising elements that realize an inductorless inverter according to the previous PCT patent application No. PCT/IT02/00448 in the name of the same applicant, both based on the same redox battery;

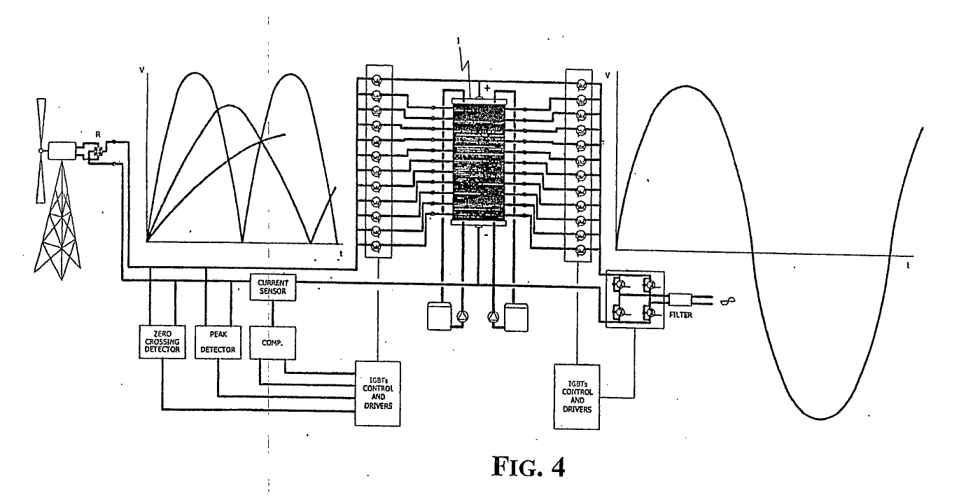

FIG. 4 is a basic scheme of an application of this invention to an aeolian power plant;

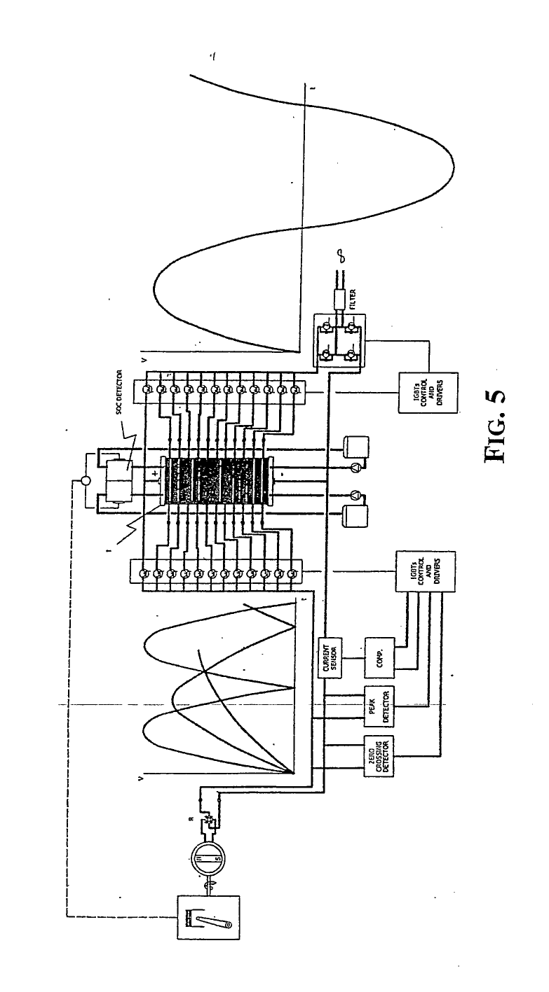

FIG. 5 is a basic scheme of an application of this invention to an engine driven electrical generator;

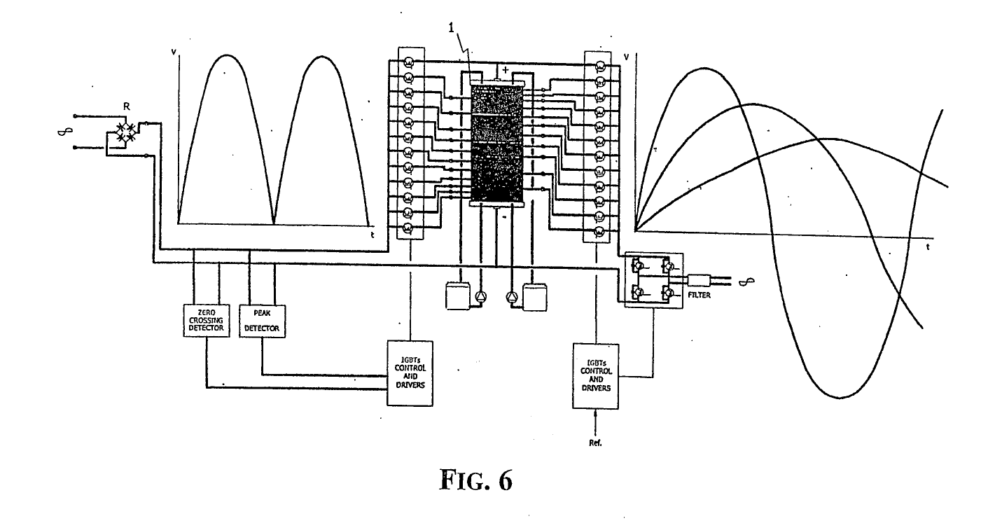

FIG. 6 is a basic scheme of a motor controller made according to the present invention;

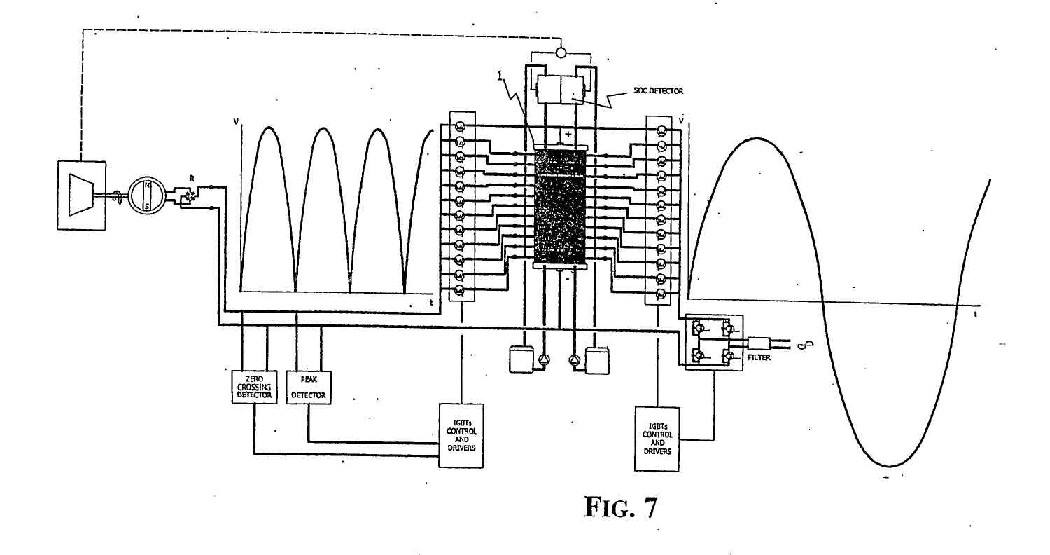

FIG. 7 is a basic scheme of a turbine power plant according to the present invention;

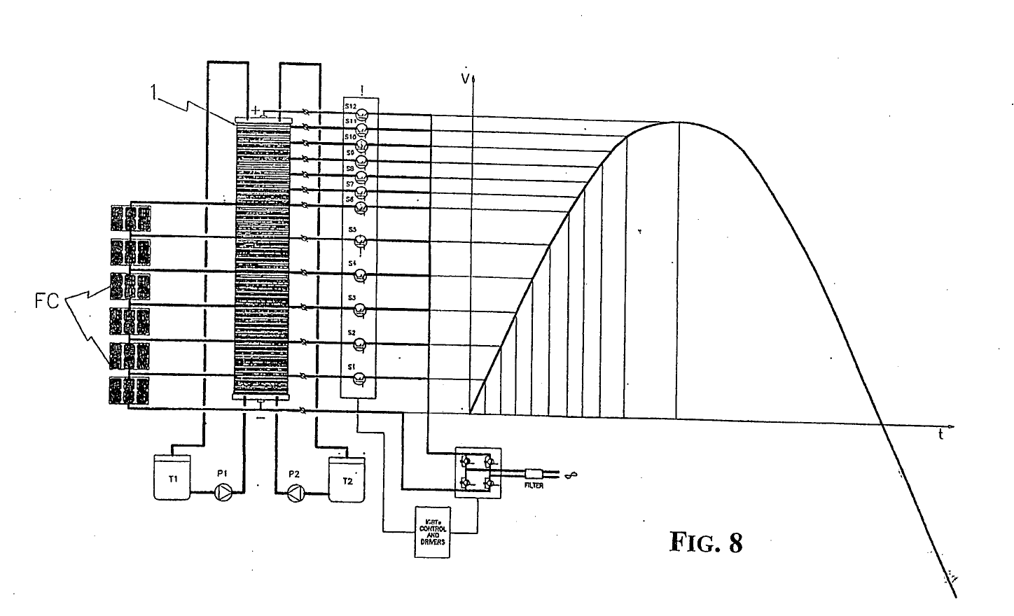

FIG. 8 is a simplified basic diagram of an application of the system of this invention to a solar power plant employing photovoltaic panels.

FIG. 1 shows a basic diagram of a system of the present invention. The redox battery is indicated as a whole with 1 and is composed of a plurality of elementary cells, electrically in series, having a certain cell voltage. The number of cells may be of several tens or even of several hundreds of cells. Considering that the cell voltage of a vanadium-vanadium redox battery system has an usefull range comprised between the upper limit of about 1.5 Volts, corresponding to a state of charge of the electrolytic solutions flowing in the cell compartments of about 90%, and a lower limit of about 1.1 Volts, corresponding to a state of charge of the electrolytic solutions flown in the cells of about 10%, the maximum battery voltage and thus the maximum input voltage that can be handled by a single battery 1 will correspond to the product of the maximum cell voltage by the number of elementary cell electrically in series.

Obviously, the value of the maximum peak voltage of the particular electrical source will determine, in designing the storage plant, the minimum number of elementary cells in series that form a single battery or eventually the total number of elementary cells of two or more multi-cell batteries connected in series.

In the simplified diagram of FIG. 1, are also indicated the two circulation circuits of the positive and negative electrolytic solutions (briefly electrolytes) that are forced by pumps P1 and P2 to flow in cascade respectively through the half-cell compartments containing the positive electrode and through the half-cell compartments containing the negative electrode of the elementary cells that constitute the battery. Obviously, the energy storage capacity is determined by the molarity of the element or elements constituting the redox couples in the electrolytic solutions and the volumes of the positive and negative electrolytes and therefore it can be easily adapted to the needs, by using tanks of the positive electrolyte T1 and of the negative electrolyte T2 of sufficient capacity to contain a sufficient amount of solution.

Between the negative and positive terminals of the battery 1, there is a certain number of intermediate voltage laps V1, V2, V3, V4, . . . V11, that in the depicted example are eleven.

The intermediate voltage taps can be easily realized by suitably shaping the respective bipolar plates or conducting septa that separate the compartment of a first polarity of an elementary cell from the compartment of opposite polarity of the adjacent elementary cell, such to have one or more appendices with the function of electric terminal protruding beyond the perimeter of the hydraulic sealing gasketing of the respective flow compartment of the cells.

Commonly, the cell electrode of said first polarity and the cell electrode of said opposite polarity are mechanically and electrically connected to the two opposite faces of these bipolar plates or secta made of conducting material, according to the typical configuration of so-called “filter-press” bipolar electrolyzers.

Therefore, each intermediate tap, will be at a voltage, conventionally referred to the negative terminal of the battery considered as a circuit node at common potential, that is a multiple of the cell voltage, corresponding to the number of cells intercepted by the intermediate tap between the negative terminal of the battery and the cell terminating with the conducting bipolar sectum of the intermediate tap. Of course the cell voltage, as already said, is not constant but depends on the state of charge of the electrolytic solutions that are in the cell compartments.

Each intermediate tap as well as the positive terminal (+) of the battery is connectable through a respective power switch SW1, SW2, . . . , SW10, SW11, to the output node of a rectifying stage (in the depicted example and most preferably is a full-wave stage) that is coupled to the AC source Vin, while the negative terminal (−) of the battery 1 is connected to the common potential node of the circuit including the rectifying stage.

The output nodes of the rectifying stage are also coupled to the inputs of a zero voltage detector ZERO CROSSING DETECTOR and of a peak detecting circuit PEAK DETECTOR. Of course, said functional circuits may be any known circuit accomplishing the specified function, designed to be compatible with the rectified voltage range of the particular AC source.

Both said functional circuits, namely: ZERO CROSSING DETECTOR and PEAK DETECTOR output a logic signal whose state confirms the detection of a null input voltage and of a voltage peak, respectively.

The block IGBT CONTROL AND DRIVER contains the logic circuits that determine in real time mode the frequency of the input AC voltage in function of the interval between the instant of detection of a null voltage and the instant of detection of a voltage peak corresponding to a quadrant (or a quarter of the period of the alternated input voltage), the circuits that generate a clock signal whose period varies in function of the detected frequency of the input AC voltage (for example circuits based on the use frequency multipliers), a state machine or a microprocessor for commanding sequentially and cyclically in a continuous mode the turning on, for a certain time or phase interval and without phase ovelappings, a switch at a time of the array of power switches SW1, SW2, . . . SW11, starting from switch SW1 when the null voltage of the rectified waveform is detected as established by the activation of the first logic conditioning signal L0 generated by the null-voltage detector ZERO CROSSING DETECTOR, up to the switch SW11 that connects the positive terminal (+) of the battery, and for reversing the scanning sequence from SW11 to SW1 when a peak of the rectified waveform is detected, as established by the activation of the second conditioning signal L1 generated by the peak detector PEAK DETECTOR.

The phases of sequential turn on of the different power switches may have substantially the same duration, that is the sequential phase switchings may take place at regular intervals corresponding to a subdivision by uniform time intervals or phases of the quadrant or of the quarter of a period of the rectified waveform.

In this case, as graphically depicted in FIG. 1, voltage taps should preferably be disposed not at regular spacings, in terms of number of cells between a tap and the successive, but according to a scheme of not uniform separation, in terms of number of cells, corresponding to the cosine function.

As an alternative, the switching phases of sequential turn on of distinct power switches may have a non uniform duration according to the same cosine function or even according to a different periodic function, depending on the voltage waveform of the AC source, for example by programming the phase switching instants of the various switches on a read only memory, which is read by a microprocessor present in the controlling and driving block IGBT CONTROL AND DRIVER.

In this case the separation, in terms of number of cells, between any two adjacent intermediate taps can be uniform.

In practice, in case of sinusoidal or almost sinusoidal input voltages, an optimization of the switching phases may be alternatively implemented with constant turn on times and intermediate voltage taps not uniformly spaced, in terms of number of cells, or with a disposition of the intermediate voltage taps at constant distance of separation, in terms of number of cells, and not uniform turn on times of the switches.

Obviously, the discretization of the rectified voltage waveform may be more or less coarse depending on the number of switching phases in each single quadrant and/or on the number of intermediate voltage taps available.

FIG. 2 depicts and alternative embodiment of a battery charger system of this invention.

The difference, in respect to the first basic embodiment of FIG. 1, is the presence of a sensing circuit CURRENT SENSOR of the charge current that is forced through the cells in electrical series of the battery that produces a signal proportional to the charge current, and of a double-threshold or window comparator HIGH LIMIT COMPARATOR, LOW LIMIT COMPARATOR for comparing the signal indicative of the charge current during each switching phase with a maximum reference voltage threshold Th_{MAX} and with a minimum reference threshold Th_{MIN}.

The activation of one or the other of the output logic signals L_{M} and Lₘ of the window comparator, produces in practice a third conditioning signal that is input to the control block IGBT CONTROL AND DRIVER.

According to this alternative embodiment of the system of this invention, it is possible to establish the maximum and the minimum charge current of the cells of the battery by fixing the values of said maximum reference threshold, Th_{MAX}, and said minimum reference threshold, Th_{MIN}, thus defining the optimal range of variation of the charge current for the charging process of the electrolytic solutions flown through the compartments of the cells of the battery.

By monitoring the charge current that is effectively forced through the elementary cells of the battery comprised between the negative terminal of the battery and the intermediate tap that is connected to the output node of the rectifier, and by comparing it with pre-established maximum and minimum threshold values a logic signal is generated when one of said pre-established threshold is exceeded.

Upon the activation of such a third conditioning signal, the algorithm implemented in the block IGBT CONTROL AND DRIVER turns off the switch that is on and turns on the switch of the adjacent intermediate tap at higher or lower voltage than the voltage of the intermediate tap that has just been isolated depending on whether the minimum or the maximum threshold of charge current has been exceeded during the switching phase just finished.

The battery charger system of this invention can be integrated with or associated to the inverter system based on the use of a redox battery described of the already cited PCT patent application No. PCT/IT02/00448, in the name of the same Applicant, by merging and/or sharing many features of the two systems, respectively for charging a redox flow battery and for delivering AC power therefrom, thus realizing a system of energy storage in a redox flow battery capable of exploiting electrical AC sources and of delivering power to electric loads operating at an alternate voltage.

FIG. 3 depicts a basic diagram of such an unified system.

The power switches SW1, SW2, . . . , SW12 are depicted together with respective current recirculation diodes, necessary when driving inductive loads, as it is well known to a technician skilled in the field of electronic power devices.

The two terminals POWER I/O represent in this case the input nodes during the charge process of the redox flow battery 1 and the output nodes during the discharge process, when powering electric loads connectable to the terminals.

As described in the above mentioned previous patent application, the output bridge, constituted by four power switches, SW13, SW14, SW15 and SW16, properly driven by the control and drive circuit CONTROL AND DRIVERS, selects the electric path, inverting the output current paths (i.e. the sign) every half-period of the constructed sinusoid of the AC alternate supply voltage that is applied the load or loads. The same output bridge, functionally configured by the control circuit, constitutes a full wave rectifier when charging the battery, thus replicating (during a charge phase) the functional scheme of the battery charger system of FIG. 1, as described above.

According to this basic embodiment of a unified system, there is only one array of power switches SW1, SW2, . . . , SW12 of “discretization” of the waveform thus avoiding a duplication thereof.

During the discharging process, the power switches of the array switch sequentially and cyclically in a continuous mode for a time interval corresponding to a fraction of appropriate duration as established by the control program, of a quarter of the period of the alternate voltage at which power is delivered to the electric load thus reconstructing a succession of half-waves the polarity of which is inverted in a perfectly synchronous manner every half-period by the output bridge.

Obviously, in case of the “unified” charge and discharge system of FIG. 3, an uniform spacing distribution of the intermediate voltages taps is preferable, the discretization/reconstruction of a sinusoidal waveform being actuated by programming appropriate durations of the switching phases of the power switches during each quarter of a period, according to common discretization techniques of a waveform, storing the timing data relative to each switching phase in a nonvolatile read only memory that may be scanned in opposite directions for switching the power switches in the succession of quarters of the AC period.

A thorough and detailed description of the so implemented inductorless (or transformerless) inverter, as well as alternative embodiments may be found in the above mentioned previous Italian patent application.

The ability of the unified system based on the use a redox flow battery of this invention of storing and supplying energy, offers unsuspectable outstanding performances in many practical applications.

A first and most important area of application of a unified system for storing and supplying energy using a redox battery is that of wind turbines for exploiting aeolian energy.

An alternator (instead of a more expensive dynamo) driven by a windmill, generates an AC voltage the frequency of which varies in function of the rotation speed, thus is substantially inconstant.

As described above the battery charmer system of this invention self-adapts to the frequency changes of the rectified input voltage enhancing exploitation of aeolian energy under variable wind conditions.

By observing FIG. 4, the portion to the left of the battery 1 depicts essentially the same functional scheme of the battery charger system of FIG. 2.

To the right of the battery 1, there is the circuit of reconstruction of an output sinusoid waveform of pre-established frequency, that couples with the battery through a second array of voltage taps, reproducing the inductorless (or transformerless) inverter of said previous PCT patent application No. PCT/IT02/00448.

FIG. 5 basically depicts an engine driven self-generation power plant.

As it may be observed, the scheme of electric energy conversion system for charging a redox battery and for supplying an AC voltage to electric loads is, under many aspects, similar to that of FIG. 4.

In an application of this kind as in many other applications wherein the main function is transforming electrical characteristics instead of operating as a buffer (UPS), the storing capacity of the redox battery may not be even exploited, being sufficient a modest quantity of electrolytic solutions to be flown in the respective compartments of the cells that constitute the battery.

Of course, if necessary or desirable, also the intrinsic storage capacity of the redox flow battery can be extensively exploited, for example for delivering power when the engine is out of service. In this case, it will be simply necessary to design the reservoirs of the electrolytic solutions to hold a certain volume of solutions sufficient to ensure an UPS function for a desired period of time.

Differently from the common optimization approach based on the use of storage batteries exclusively with UPS functions, using a DC-DC converter and an inverter, the system of this invention, because of the ability of converting the variable frequency of the AC voltage generated by the alternator depending from the rotation speed of the engine to a pre-established fixed frequency, allows for an easily implementable and effective control of the speed of the engine in function of the power absorption of the electric load(s).

Instead of using a signal representative of the current being absorbed by the load for automatically regulate the speed of the engine, it may be even more advantageously used a sensor SOC DETECTOR of the state of charge of one or the other or both the electrolytic solutions, able of generating an electric signal whose amplitude is proportional to the state of charge of the electrolyte or electrolytes. In function of this signal, the engine speed will be increased or decreased to maintain the state of charge of the redox flow battery to the desired level. The sensor of the charge of the battery may be, for example, an instrument for measuring the redox potential of an electrolytic solution.

Obviously, any other parameter that may be correlated to the state of charge of the battery may be monitored and the relative electric signal used for regulating the speed of the engine.

By monitoring the state of charge of the battery instead of the output power, it is easier to implement a control of the speed of the engine with “slower” variation ramps, avoiding too frequent and abrupt changes by exploiting the “damping” and “delaying” effect that sudden changes of absorption by the electric load of the battery produce on the state of charge of the battery.

In practice the battery intrinsically provides for an integrating function that, should an absorbed power signal be employed would need to be actuated by means of dedicated integrating circuits.

A system of the invention may be used also for controlling an electric motor, the basic scheme of which is depicted in FIG. 6.

The redox battery charger system to the left of the battery 1 absorbs energy from the mains, obviously at a substantially fixed voltage and frequency.

The rectified sinusoidal waveform is monitored by the null voltage (ZERO CROSSING DETECTOR) and peak voltage (PEAK DETECTOR) detectors synchronizing the sequences of cyclic, not overlapping switchings of the switches connected to the intermediate voltage taps of the battery, according to the same functional scheme of FIG. 1.

Coupled to the other array of intermediate voltage taps of the battery 1 is the inverter system described in the above mentioned Italian patent. The inverter system reconstructs a sinusoidal output voltage of a frequency that may be programmed by a command REF issued by the control circuitry of the sequential and cyclic switchings of the power switches which is applied to the windings of the motor.

A motor controller according to the invention, may be extremely convenient even in the case of turbine power plants generating an AC voltage with a frequency in the order of one or several thousands of Hz, for transforming it in an AC voltage at mains frequency, for example 50 Hz. The diagram relative to this application is depicted in FIG. 7.

As shown in FIG. 7, the system may also contemplate a regulation loop of the rotation speed of the turbine, using preferably a signal representative of the state of charge of the electrolytes, similarly to the case of the engine plant of FIG. 5. The applications described in relation to FIGS. 4, 5, 6, and 7 may be, mutatis mutandis, be considered as based on the use of a system of this invention with main function of “frequency transformer”, besides the intrinsic energy storage capacity (UPS function) of the redox battery that is included in the system.

The unified energy conversion system of this invention, based on the use of a redox flow battery, besides the advantage of not requiring expensive and less efficient battery charger systems and inverters, also because of the fact that no inductors and/or transformers are needed, ensures a high power factor, eliminating in practice any phase lag between voltage and current and a low harmonic content practically in any load condition. Even the switching noise can be easily limited by using low cost filters.

The versatility of a system of the invention is fully revealed when used with a grid-connected solar power plant employing photovoltaic panels.

A grid-connected photovoltaic panel plant is normally considered as not requiring any storage battery (UPS function), being based on the transformation of the DC power produced by photovoltaic panels in AC power at mains frequency to power or contribute to power electric loads and eventually outputting any excess power on the distribution grid (mains) by using an inverter to convert the DC voltage generated by panels in an AC voltage at the mains frequency.

The photovoltaic panels are normally produced in modules that are generally compatible with the charge voltages of traditional lead batteries and thus interconnected for outputting a nominal voltage of about 14-15 Volts at certain conditions of irradiation.

Photovoltaic power plants thus contemplate, in function of the required nominal power, an array of a plurality of panels interconnected according to a proper series-parallel scheme.

Often, in order to obviate to the inconstancy of the intensity of the solar irradiation, there are configuration switches that allow to modify the series-parallel scheme, adapting it to the conditions of irradiation in the most appropriate way for outputting a DC voltage of an adequate amplitude so to allow the functioning of the solar power plant even in the case of a relatively low solar irradiation.

Moreover, these expedients are absolutely necessary in order to make a common inverter operate with an acceptable efficiency.

The inverter system described in the previous PCT patent application No. PCT/IT02/00448, even if it allows the reconstruction of the sinusoidal waveform at the mains voltage and frequency without using a traditional inverter employing an inductor or a transformer, it is not free from inefficiencies that penalize a fullest exploitation of the solar energy input to the panels.

The inverter system according to the above identified Italian patent application would not employ any battery in view of the fact that the photovoltaic modules electrically in series constitute a battery of elementary cells or modules all generating the same DC voltage that, with a stable and constant irradiation can also be considered stable and constant.

In the inverter system of the above identified Italian patent application, each module or panel the functions like a certain number of elementary cells of a redox flow battery in generating an equivalent DC voltage.

The construction of a sinusoidal AC voltage waveform by the sequential switchings of the array of power switches will generate a sinusoidal voltage whose amplitude cannot be greater than the DC voltage available at the terminals of the electrical series of all the photovoltaic panels.

In other words, according to the cited prior application, there is a limit to the amplitude that the constructed AC voltage may have. This limitation is no longer present in the unified system of this invention based on the presence of a redox flow battery. The number of elementary cells may be such to satisfy the requisite of amplitude of the sinusoidal voltage output by the system independently from the maximum DC voltage generated by the array of photovoltaic panels, which according to this invention are exploited for charging the redox battery instead of being directly used for constructing the output sinusoidal wave.

The unified system according to this invention for producing electric energy by grid-connected photovoltaic panel plant, comprising a battery charger system of a redox flow battery and an associate inverter system for outputting an AC voltage of amplitude and frequency appropriate the distribution grid characteristics is outstandingly efficient. It allows the fullest exploitation of the energy picked-up by the photovoltaic panels under any condition of solar irradiation, that is uninterruptly absorbed by the battery even at relatively low DC voltage and therefore is available for transformation in the form of an AC voltage at mains frequency.

FIG. 8 depicts a preferred embodiment of a power plants using photovoltaic panels realized according to the present invention.

In the depicted diagram, the array of photovoltaic panels FC is composed of six panels electrically in series and each interconnection node, starting from the node of a first panel of the series, the negative terminal of which is connected to the negative terminal of the battery 1 (that is to the common potential node of the circuit), is connected to a respective intermediate voltage tap of the battery such that, under full charge conditions, the voltage of the intermediate tap of the battery is more or less equal to the DC voltage generated by the panel under conditions of minimum level of solar irradiation that may be exploited by the photovoltaic cells.

In practice, in the peculiar case of plural DC sources such as the photovoltaic panels, the battery charger system of this invention may be simply realized by directly connecting the panels to respective intermediate voltage taps of the battery organized to have appropriately matching voltage levels such to allow the charging of the battery under conditions of maximum irradiation and as far as conditions of minimum irradiation, while remaining within the established range of variation of the charge current of the cells of the battery. Of course, the cells will be dimensioned, in terms of cell area, in order to satisfy this last requisite even under conditions of maximum irradiation.

As it is observable in the figure, the battery 1 has a total number of cells sufficient to ensure the availability of a DC voltage at the terminals of the battery that is substantially equal to the peak voltage of the sinusoidal wave to be output under conditions of minimum state of charge of the battery. The total number of cells of the battery is independently established from the number of photovoltaic panels that may be much less, in consideration of the power that may be provided by each panel and of the maximum power requisite of the load (or of the ratio between the power available at the input and the nominal maximum output power requisite).

The array of power switches S1, S2, S3, . . . , S12, each connected to a respective intermediate voltage tap, several of which are also connected to respective photovoltaic panels, is used to construct the output sinusoidal waveform by implementing the inductorless inverter system of the above mentioned Italian patent application.

In practice, the positive terminal of each photovoltaic panel of the array of panels electrically in series is connected to a respective intermediate voltage tap of the redox flow battery 1 and through a respective power switch, to the output of the battery based inverter system that constructs the output sinusoidal waveform.

In an application of this type, the redox battery can be considered a buffer that stores the energy gathered by the photovoltaic panels and gives it back for constructing the AC output sinusoidal waveform.

A portion of the output sinusoidal wave is constructed by drawing power directly from photovoltaic panels, which continue to charge the redox battery with any power in excess of that absorbed by the electric load of the inverter.

1. A method of storing electric energy from an AC power source in one or more redox flow batteries comprising a plurality of elementary cells electrically in series and having a certain cell voltage, the method comprising:
rectifying the AC voltage by means of a full wave rectifier;
providing for a number N of voltage taps along said electrical series of elementary cells;
providing for a number N of power switches each connecting a respective intermediate tap or a positive terminal of the electrical series of elementary cells to the output node of said rectifier;
connecting a negative terminal of said electrical series of elementary cells to a common potential node of the circuit;
detecting a null voltage of the rectified voltage producing a first conditioning and reset signal of a second conditioning signal;
detecting a peak of the rectified voltage producing said second conditioning and reset signal of said first conditioning signal;
switching sequentially and cyclically in a continuous mode and without overlappings said N switches one at a time from an instant of detection of the null voltage of the rectified wave established by the activation of said first conditioning signal each for a certain interval, up to said switch connecting the positive terminal, inverting the scan direction upon detecting a peak of said rectified voltage, established by the activation of said second conditioning signal.

2. The method according to claim 1, wherein the number of elementary cells comprised between a certain intermediate voltage tap and another intermediate voltage tap or battery terminal adjacent thereto of said electrical series of elementary cells corresponds to a voltage equivalent to that of a respective phase interval of a number N of discretization phases of a waveform of said AC voltage in a quadrant wherein turn on intervals of said switches have substantially a same duration.

3. The method of claim 1, further comprising:
monitoring a charging current flowing in the elementary cells of said battery comprised between the negative terminal of the battery and the intermediate voltage tap connected to the output node of said rectifier;
comparing said charging current with a pre-established maximum threshold and a minimum threshold, and generating a third conditioning signal when one of said thresholds is surpassed;
turning off, upon activation of said third conditioning signal, a switch currently in a conduction state and turning on the switch of the adjacent intermediate voltage tap at higher or at lower voltage than the voltage of the intermediate voltage tap of the switch just turned off depending on which of said maximum and minimum charging current thresholds has been surpassed during the just concluded switching phase.

4. The method according to claim 1, a condition of no overlap of a turn-on phase of a switch with that of another switch is ensured by a logic circuit mans.

5. The method according to claim 1, wherein a condition of no overlap of a turn-on phase of a switch with that of another switch is ensured by establishing a guard interval between a turn off instant and a successive turn on instant.

6. An electrochemical storage system of electric energy from an AC source in one or more redox flow batteries comprising a plurality of elementary cells electrically in series and having a certain cell voltage, the system comprising:
at least a full wave rectifier coupled to said AC source;
at least a redox battery composed of a plurality of elementary cells electrically in series and having a first array of a number N of intermediate voltage taps along said electrical series of elementary cells;
a number N of first power switches each connecting a respective intermediate tap of said first array or a positive terminal of the electrical series of elementary cells to an output node of said rectifier, and a negative terminal of said electrical series of elementary cells being connected to a common potential node;
means for detecting a null value of the rectified AC voltage producing a first conditioning and reset signal disabling a second conditioning signal;
means for detecting a peak of the rectified AC voltage producing said second conditioning and reset signal disabling said first conditioning signal;
means for switching sequentially and cyclically in a continuous mode and without overlappings, for a certain interval said N switches one at a time starting from an instant of detection of a null value of the rectified voltage waveform as established by the activation of said first conditioning signal, up to said switch connecting a positive terminal of said electrical series, and for inverting the scan direction at the instant of detection of peak of the rectified voltage waveform as established by the activation of said second conditioning signal.

7. The electrochemical storage system of claim 6, wherein the number of elementary cells comprised between a certain intermediate voltage tap and another intermediate voltage tap or battery terminal adjacent thereto said electrical series of elementary cells corresponds to a voltage equivalent to that of a respective phase interval of a number N of discretization phases of a waveform of said AC voltage in a quadrant, wherein turn on intervals of said switches have substantially a same duration.

8. The electrochemical storage system of claim 6, further comprising:
means for monitoring a charging current flowing in the elementary cells of said battery comprised between the negative terminal of the battery and the intermediate voltage tap connected to the output node of said rectifier;
means for comparing said current with a pre-established maximum threshold and minimum threshold, and for generating a third conditioning signal when one of said thresholds is surpassed.
wherein said means for sequentially switching switch at an activation of said third conditioning signal, switching off a switch currently in a conduction state and turning on a switch of an adjacent intermediate voltage tap at a higher or lower voltage than a voltage of the intermediate voltage tap that has been switched off if either said maximum or said minimum charging current threshold has been surpassed during a just concluded switching phase.

9. The system according to any any one of claims 6 to 8, further comprising logic circuit means for ensuring a condition of no overlap of a turn-on phase of a switch with that of another switch.

10. The electrochemical system according to any one of claims 6 to 8, further comprising circuit means for establishing a guard interval between a turn-off instant and a successive turn-on instant.

11. An electrochemical system for transforming electrical energy from an AC source of any frequency in electrical energy deliverable to an electrical load at a certain AC voltage and frequency, the system comprising:
at least a full wave rectifier coupled to said AC source;
at least a redox battery comprising a plurality of elementary cells electrically in series and including a first array of a number N of intermediate voltage taps along said electrical series of elementary cells;
a number N of first power switches each connecting a respective intermediate tap of said first array or a positive terminal of the electrical series of elementary cells to an output node of said rectifier, and a negative terminal of said electrical series of elementary cells being connected to a common potential node;
means for detecting a null value of the rectified voltage generating a first conditioning and reset signal disabling a second conditioning signal; means for detecting a peak of said rectified voltage producing said second conditioning and reset signal disabling said first conditioning signal;
means for switching sequentially and cyclically in a continuous mode and without overlappings, for a certain interval said N switches one at a time starting from an instant of detection of the null value of the rectified voltage waveform as established by the activation of said first conditioning signal, up to said switch connecting the positive terminal of said electrical series, inverting the scan direction at the instant of detection of a peak of the rectified voltage waveform as established by the activation of said second conditioning signal;
a second array of a number M of intermediate voltage taps along said series of elementary cells such that the number of elementary cells comprised between a certain intermediate tap and another tap or an end terminal of the battery adjacent thereto of said series of elementary cells corresponds to a voltage value represented by a maximum voltage value in a respective phase interval of a number M of discretization phases of the waveform of said certain AC voltage in a quadrant;
a number M of second power switches each connecting either a respective tap or a first terminal of a first polarity of said electrical series of elementary cells to a common voltage node of said electrical load circuit;
a bridge stage for inverting the output current path, composed of at least four power switches, having a first pair of nodes coupled respectively to said common voltage node and to the other terminal of said electrical series of elementary cells of polarity opposite to said first polarity and a second pair of nodes constituting an AC power output;
means for switching sequentially and cyclically in continuous mode one at a time said M second switches, each for a time interval corresponding to 1/(4M) the period of said output AC voltage and for switching by pairs said four switches of said bridge stage at every half-period of said output AC voltage.

12. The electrochemical system of claim 11, wherein the N voltage taps of said first array coincide with the M voltage taps of said second array.

13. The electrochemical system of claim 12, wherein said voltage taps are disposed at regular intervals of a certain number of elementary cells in series.

14. The electrochemical system of claim 13, further comprising:
means for monitoring a charging current flowing in the elementary cells of said battery comprised between the negative terminal of the battery and the intermediate voltage tap connected to the output node of said rectifier;
means for comparing said current with a pre-established maximum threshold and minimum threshold, generating a third conditioning signal when one of said thresholds is surpassed;
means for switching off, upon activation of said third conditioning signal, a switch currently in a conduction state and for turning on a switch of an adjacent intermediate voltage tap at higher or at lower voltage than the voltage of the intermediate voltage tap of the switch just switched off if either said maximum or said minimum charging current threshold has been surpassed during the just concluded switching phase.

15. An aeolian power plant comprising:
at least a wind driven electrical alternator generating an AC voltage of variable amplitude and frequency; and
the electrochemical system of claim 11 which transforms electrical energy produced by said alternator in AC electrical energy of pre-established and constant frequency and amplitude.

16. An aeolian power plant comprising:
at least an internal combustion engine driving an electrical alternator generating an AC voltage of variable amplitude and frequency: and
the electrochemical system of claim 11 which transforms electrical energy produced by said alternator in AC electrical energy of pre-established and constant amplitude and frequency.

17. The power plant of claim 16, further comprising at least a detector of a charge of at least an electrolytic solution of the redox battery and means for varying a speed of the engine responsive to a signal produced by said detector.

18. A power plant comprising:
at least a turbine driven electrical alternator generating an AC voltage of variable amplitude and frequency; and
the electrochemical system of claim 11 which transforms energy produced by said alternator in AC electrical energy of pre-established and constant amplitude and frequency.

19. The power plant of claim 18, further comprising at least a detector of a charge of at least an electrolytic solution of the redox battery; and
means for varying the rotation speed of the turbine in function of a signal produced by said detector.

20. A controller for an electrical AC motor connectable to a mains the controller comprising:
means for regulating a speed of the motor by varying a frequency of an applied AC voltage;
the electrochemical system of claim 11 which transforms electrical energy at a voltage and a frequency of the mains in electrical energy supplied to the motor at an AC voltage the amplitude and frequency which is established by a command which regulates the speed of the motor applied to an input of a control and driving circuit of said second array of power switches.

21. An aeolian power plant, comprising:
a plurality of photovoltaic panels electrically in series; and
at least an inverter for transforming a DC electrical energy at a voltage generated by said panels in electrical energy at the mains voltage and frequency, wherein said inverter comprises:
at least a redox battery composed of a plurality of elementary cells of a certain cell voltage electrically in series and including a number N of intermediate voltage taps along said series of elementary cells that constitute the battery;
a number N of power switches each connecting either a respective tap or a positive node of the battery to a first input of a bridge stage for inverting the output current path composed of four switches driven in pairs having a second input connected to a negative terminal of the battery, and to the negative terminal of a first photovoltaic panel of said plurality of panels connected in series;
the positive terminal of each of said photovoltaic panels being connected to a respective intermediate voltage tap of the battery at a voltage lower than the DC voltage generated on the relative positive terminal of the panel of said series, referred to the potential of said negative terminal of the battery, and of the first photovoltaic panel of the series;
means for switching sequentially and cyclically in continuous mode one at a time said M second switches; each for a time interval corresponding to 1/(4M) the period of said AC voltage and for switching by pairs said four switches of said bridge stage at every half-period of said AC voltage.
